(19) United States
(12) Patent Application Publication
(10) Pub. No.: US 2006/0236926 A1
(43) Pub. Date: Oct. 26, 2006

(54) Semiconductor manufacturing apparatus

(75) Inventors: Katsuyasu Shiba, Yokkaichi (JP); Jota Fukuhara, Yokkaichi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/391,260

(22) Filed: Mar. 29, 2006

(30) Foreign Application Priority Data
Mar. 30, 2005 (JP) 2005-099581

(51) Int. Cl. B05C 13/02

(52) U.S. Cl. 118/52

(57) ABSTRACT

A semiconductor manufacturing apparatus includes a main piping distributing an insulating film forming chemical solution onto a semiconductor substrate, and an auxiliary piping provided so as to surround the main piping so that a liquid chemically nonreactive to the insulating film forming chemical solution flows therethrough.

### CROSS-REFERENCE TO RELATED APPLICATIONS

This application is based upon and claims the benefit of priority from the prior Japanese Patent Application No. 2005-99581, filed on Mar. 30, 2005, the entire contents of which are incorporated herein by reference.

### BACKGROUND OF THE INVENTION

1. Field of the Invention

The present invention relates to a semiconductor manufacturing apparatus for applying a liquid to a semiconductor substrate.

2. Description of the Related Art

When a liquid is applied to a semiconductor substrate, an applying liquid stored in a liquid storage tank is generally discharged through piping from an outlet of the piping thereby to be applied to the semiconductor substrate. In this case, when the applying liquid flows through the piping, a temperature of the piping affects a change in the temperature of the applying liquid. Accordingly, the piping structure needs to be devised so that the applying liquid is discharged from the outlet with the temperature of the liquid being stabilized.

In view of the aforementioned requirement, JP-A-2-184031 and JP-A-3-241829 each disclose a double pipe structure in which water is caused to flow through an outer pipe surrounding a central pipe through which water flows, thereby stabilizing the temperature of the applying liquid.

With recent refinement of elements or devices and reduction in the design rules, a memory cell composing, for example, a non-volatile semiconductor device has had an increasing degree of integration. An element isolation region providing insulation between adjacent memory cells is required to be reduced. In view of the requirement, a shallow trench isolation (STI) structure is employed in the element isolation region. In order that an element isolation film may be formed in an element isolation region of the STI structure, an insulating film forming chemical such as a solution of polysilazane is sometimes applied to a semiconductor substrate.

It can easily be conceived that the temperature of the chemical solution can be stabilized by circulating water through an outer pipe surrounding a central pipe to which an insulating film forming chemical solution has been supplied, with the techniques of the above-notified gazettes being applied.

However, for example, the piping is sometimes moved in a regular maintenance. When the piping is subjected to a physical impact due to personnel's carelessness, there is a possibility that the pipe through which the insulating film forming chemical solution may be damaged. For example, if the pipe through which the insulating film forming chemical solution should be damaged and the chemical solution should be brought into contact with another liquid, a poisonous gas or heat would be produced.

### SUMMARY OF THE INVENTION

Therefore, an object of the present invention is to provide a semiconductor manufacturing apparatus which applies an insulation film forming chemical solution to a semiconductor substrate and can maintain safety upon breakage of the pipe through which the chemical solution flows.

The invention provides a semiconductor manufacturing apparatus comprising a main piping distributing an insulating film forming chemical solution onto a semiconductor substrate; and an auxiliary piping provided so as to surround the main piping so that a liquid chemically nonreactive to the insulating film forming chemical solution flows therethrough.

### BRIEF DESCRIPTION OF THE DRAWINGS

Other objects, features and advantages of the present invention will become clear upon reviewing the following description of the embodiment with reference to the accompanying drawings, in which:

FIG. 1 is a schematic diagram of a semiconductor device manufacturing apparatus in accordance with a first embodiment of the present invention;

FIGS. 2A and 2B are longitudinal and transverse sections of an end of piping including an outlet respectively; and

FIGS. 3A and 3B are views similar to FIGS. 2A and 2B respectively, showing the semiconductor device manufacturing apparatus in accordance with a second embodiment of the present invention.

### DETAILED DESCRIPTION OF THE INVENTION

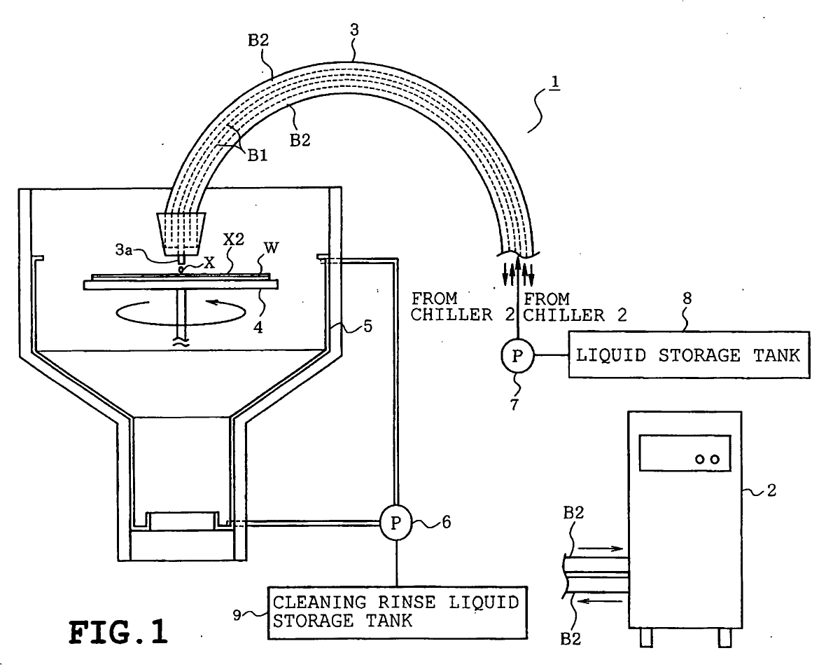

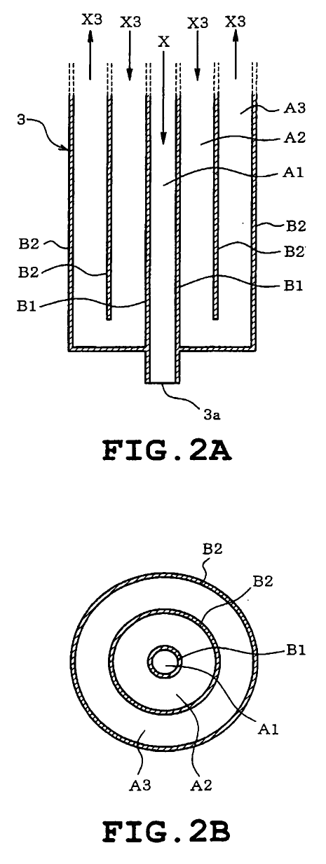

A first embodiment of the present invention will be described with reference to FIGS. 1 to 2B. Referring to FIG. 1, a semiconductor device manufacturing apparatus of the first embodiment is schematically shown. The semiconductor device manufacturing apparatus 1 comprises a chiller 2 serving as a circulator, piping 3, a spin coater 4 serving as a rotating mechanism, a coater cup 5, a flowing mechanism pump 6, a pump 7 serving as a rinse liquid circulator, a liquid storage tank 8 and a cleaning rinse liquid storage tank 9. An insulating film forming chemical X is a solution of polysilazane; for example and is stored in the liquid storage tank 8. The chemical X is supplied from the liquid storage tank 8 through the pump 7 and piping 3 to be discharged from an outlet 3a of the piping 3.

In the semiconductor device manufacturing apparatus 1, a semiconductor substrate W is placed on the spin coater 4. The insulating film forming chemical X is dropped (supplied) onto substantially a central flat surface of the semiconductor substrate W while the substrate is on the spin coater 4. An electric motor (not shown) is driven to rotate the spin coater 4 at a predetermined rotational speed, so that an applied insulating film X2 is formed on the semiconductor substrate W.

The spin-on insulating film X2 is formed as a polysilazane film, for example, and recently used to fill an element isolation region with the shallow trench isolation (STI) structure. A tetra ethoxy silane (TEOS) film or the like has conventionally been formed in the element isolation region. However, the element isolation region isolating an active region has been narrowed with reduction in the design rules. In view of the narrow element isolation region, a spin-on insulating film having good embeddability is used. The spin-on insulating film X2 needs to be formed so as to have in-plane uniformity on the semiconductor substrate W in order to be embedded in the element isolation region uniformly. The temperature control is particularly important in application of the insulating film forming chemical X in order that the in-plane uniformity may be controlled. Then, when the insulating film forming chemical X is applied, the temperature of the insulating film forming chemical X needs to be constant. For example, a water channel needs to be provided around a main piping B1 to distribute the insulating film forming chemical X when the temperature of the insulating film forming chemical X is kept constant by application of the technique of JP-A-2-184031 or JP-A-3-241820. In this case, when a solution of polysilazane is particularly applied to as the insulating film forming chemical X, hydrogen, ammonia gas, SiH₄ gas or heat would be produced and SiO₂ particle would be formed if the main piping B1 should be exploded such that polysilazane would react with water. In this case, there is a possibility of danger around the semiconductor manufacturing apparatus. Furthermore, the SiO₂ particle would results in clogging of piping.

In view of the foregoing problems, the embodiment is characterized by the structure of piping 3 for supplying the insulating film forming chemical X onto the semiconductor substrate W in order that the temperature may be adjusted so as to be substantially constant (for example, 23° C.±0.5° C.) while safety is ensured around the apparatus.

FIG. 2A schematically shows the longitudinally sectional structure of an outlet of the piping. FIG. 2B schematically shows the transversely sectional structure of the piping. As shown in FIGS. 2A and 2B, the piping 3 has a concentric triple pipe structure. The piping 3 includes a central main piping B1 (divided piping, central piping and first piping) and an auxiliary piping B2 (second piping) which is disposed so as to surround at least an outer circumference of the outlet 3a.

The main piping B1 has a supply port (not shown) through which the insulating film forming chemical X is supplied. The supply port is connected to a pump 7. The pump 7 drops (supplies) the insulating film forming chemical X from the liquid storage tank 8 through a central flow passage (corresponding to a first flow passage) and the outlet 3a over the semiconductor substrate W. The outlet 3a of the main piping B1 is fixed at a position spaced, for example, 2 cm above the semiconductor substrate W.

The auxiliary piping 52 is connected to the chiller 2. The chiller 2 is provided for cooling a temperature adjusting liquid X3 and usually circulating the temperature adjusting liquid X3 through the auxiliary piping B2 to a position (a position spaced 3 cm above the semiconductor substrate W, for example) near the outlet 3a.

It is desirable that the temperature adjusting liquid X3 should be made from a material chemically non-reactive against the insulating film forming chemical X. The reason for this is that chemically ill affection could be prevented even if the main piping B1 should be broken. Furthermore, it is desirable that the temperature adjusting liquid X3 should be made from a material chemically non-reactive against water. The reason for this is that chemically ill affection could be prevented even if water should be adherent to the piping 3 and mixed with the temperature adjusting liquid X3 through a crack in the auxiliary piping B2.

Furthermore, a desirable temperature adjusting liquid X3 includes chemicals containing no hydroxide, for example, a liquid containing as an active component at least one of liquids of C₁₀H₈, C₁₀H₁₂, C₁₁H₁₄, C₁₂H₁₆, C₁₃H₁₈ and C₁₄H₂₀. Furthermore, a desirable temperature adjusting liquid X3 includes a liquid containing dibutyl ether (C₈H₁₈O) as an active component. As a result, the temperature can efficiently be stabilized.

Referring to FIG. 2A, the temperature adjusting liquid X3, after having been cooled, flows through a second liquid passage A2 inside the chiller 2 near to the outlet 3a and returns through a third liquid passage A3 located outside the second liquid passage A2 to the chiller 2, thereby being circulated. When the interior of the main piping B1 serves as a central flow passage A1, the second liquid passage A2 is a liquid passage (flow passage) divided by the main piping B1 located immediately around the central passage A1. A third liquid passage A3 is divided by the auxiliary piping B2 located immediately around the second liquid passage A2. Furthermore, a spin-coater 4 is provided for rotating the semiconductor substrate W. The spin-coater 4 is driven by an electric motor (not shown) so that the semiconductor substrate W is rotated. When the semiconductor substrate W is rotated by the spin-coater 4 after the insulating film forming chemical X has been dropped onto the semiconductor substrate W, the dropped insulating film forming chemical X fills a trench previously formed in the semiconductor substrate W, and the residual liquid is spun outside the semiconductor substrate W. A coater cup 5 is provided for receiving spun liquid drops. The coater cup 5 is disposed around the spin-coater 4. On the other hand, a pump 6 supplies cleaning rinse liquid stored in the storage tank 9 into an upper interior of the coater cup 5 (at least a location above the location of the semiconductor wafer W, whereby the residual liquid adherent to the coater cup 5 can be cleaned.

A desirable cleaning rinse liquid includes chemicals containing no hydroxide, for example, a liquid containing as an active component at least one of liquids of C₁₀H₈, C₁₀H₁₂, C₁₁H₁₄, C₁₂H₁₆, C₁₃H₁₈ and C₁₄H₂₀. Furthermore, the desirable cleaning rinse liquid includes a liquid containing dibutyl ether (C₈H₁₈O) as an active component. As a result, the residual insulating film forming chemical X adherent to the coater cup 5 can efficiently be cleaned off.

When the coater cup 5 receives the residual insulating film forming chemical X, the residual and cleaning rinse liquid are stored in a lower interior of the coater cup 5. The pump 6 is operated to pump up the residual and cleaning rinse liquid stored in the coater cup 5 to an upper interior of the coater cup 5, whereby the residual and cleaning rinse liquid can be re-used as the cleaning rinse liquid. Since the cleaning rinse liquid is thus circulated by the pump 6, the cleaning rinse liquid can be recycled.

The inventors conducted an experiment in which a liquid (name: HC-300) containing all of C₁₀H₈, C₁₀H₁₂, C₁₁H₁₄, C₁₂H₁₆, C₁₃H₁₈ and C₁₄H₂₀. According to the experiment, when the manufacturing apparatus is provided with no circulating function by the pump 6, particles produced on the semiconductor substrate W increases over 500 when 3000 spin-on insulating films X2 have been applied to the semiconductor substrate W. On the other hand, when the coater cup 5 with the circulating function is used, the number of particles produced is not more than 10 even when 6000 spin-on insulating films X2 have been applied to the semiconductor substrate W. As a result, the yield can be improved.

The operation of the apparatus in the formation of a spin-on insulating film will be described. The pump 7 supplies the insulating film forming chemical X from the liquid storage tank 8 through the main piping B1 and the outlet 3a onto the semiconductor substrate W. The insulating film forming chemical X supplied on the semiconductor substrate W is uniformly applied to the semiconductor substrate W by the spin coater 4. At this time, the chiller 2 cools the temperature adjusting liquid X3 stored therein and causes the temperature adjusting liquid X3 to circulate through the auxiliary piping B2. Heat of the temperature adjusting liquid X3 is conducted via the main piping B1 to the insulating film forming chemical X, whereupon the temperature of insulating film forming chemical X is kept constant.

The auxiliary piping B2 extends near to the outlet 3a, the temperature of the insulating film forming chemical X can be kept constant immediately until the insulating film forming chemical X is discharged out of the piping 3.

As described above, the piping 3 is constructed as follows: the insulating film forming chemical X and the temperature adjusting liquid X3 chemically non-reactive against the chemical X are caused to flow through the second liquid passage A2 divided by the main piping B1 provided immediately around the central flow passage A1. The insulating film forming chemical X1 can be caused to flow through the central flow passage A1 inside the main piping B1 thereby to be supplied onto the semiconductor substrate W. As a result, the temperature of the insulating film forming chemical X1 can be kept constant. Moreover, since the temperature adjusting liquid X3 flowing into the auxiliary piping B2 is circulated, the temperature of the insulating film forming chemical X1 can be kept constant.

Furthermore, since the insulating film forming chemical X1 is chemically non-reactive against the temperature adjusting liquid X3, safety could be kept even if the main piping B1 should be broken. Still furthermore, when a liquid which is chemically non-reactive against water is employed as the temperature adjusting liquid X3, chemical reaction could be prevented even if water should be adherent to the piping 3 and mixed with the temperature adjusting liquid X3 through a crack in the auxiliary piping B2. Consequently, safety can further be ensured.

Additionally, after the insulating film forming chemical X has been dropped through the piping 3 onto the semiconductor substrate W, the spin coater 4 rotates the semiconductor substrate W and the coater cup 5 receives the drops of the insulating film forming chemical X spun out of the semiconductor substrate W. The cleaning rinse liquid is pumped up to the upper interior of the coater cup 5 by the pump 6, so that the insulating film forming chemical X adherent to the coater cup 5 is cleaned. Consequently, the residual adherent to the coater cup 5 can be cleaned.

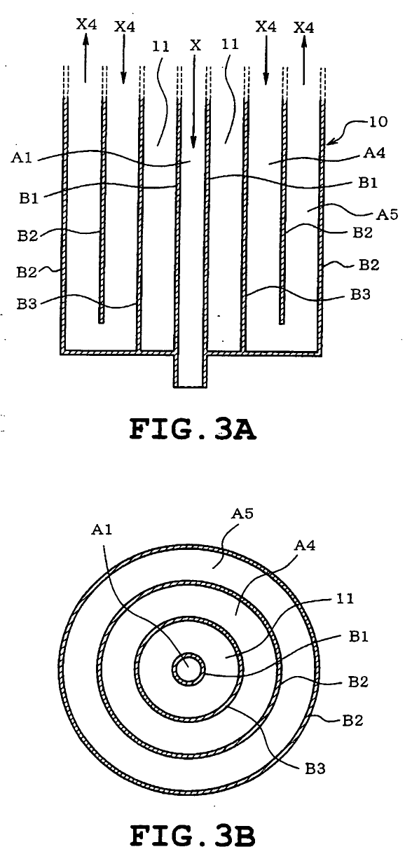

FIG. 3 illustrates a second embodiment of the invention. The second embodiment differs from the first embodiment in that the piping has a quadruple pipe structure. Identical or similar parts in the second embodiment are labeled by the same reference symbols as those in the first embodiment and accordingly, detailed description of these parts will be eliminated. Only the difference will be described as follows.

Referring to FIG. 3, piping 10 employed instead of the piping 3 has a quadruple pipe structure. The piping 10 also includes a main piping B1 and an auxiliary piping B2 as the piping 3 does. A separating piping B3 is provided for separating the main piping B1 and the auxiliary piping B2 with a residuary piping 11 interposed therebetween. The separating piping B3 separates the residuary piping 11 disposed immediately around the main piping B1 and a fourth liquid passage A4 provided around the separating piping B3. The residuary passage 11 functions as a liquid passage divided by the main piping B1 or a separating passage.

The liquid chemically non-reactive against the insulating film forming chemical X serves as the temperature adjusting liquid X3 in the first embodiment. In the second embodiment, however, water is applied to the temperature adjusting liquid X4 instead of the temperature adjusting liquid X3. Water is applied since water is generally supplied from the chiller 2. The liquid chemically non-reactive against the insulating film forming chemical X may be applied to the temperature adjusting liquid X4 as in the first embodiment.

The chiller 2 supplies the temperature adjusting liquid X4 to the fourth and fifth liquid passages A4 and A5 limited by the auxiliary piping B2 and the separating piping B3 respectively, so that the liquid X4 is recirculated. The fourth and fifth liquid passages A4 and A5 have substantially the same flow passage structure as the second and third liquid passages A2 and A3. Accordingly, detailed description of these liquid passages A4 and A5 will be eliminated.

In the second embodiment, the distance between the main and auxiliary pipings B1 and B2 is larger than in the first embodiment. Accordingly, even if water is supplied as the temperature adjusting liquid X4 to the liquid passages A4 and A5, there is a low possibility of contact of the insulating film forming chemical X and water, whereupon safety can be ensured.

A desirable buffer liquid includes a liquid chemically non-reactive against the insulating film forming chemical X, for example, a liquid containing as an active component at least one of liquids of C₁₀H₈, C₁₀H₁₂, C₁₁H₁₄, C₁₂H₁₆, C₁₃H₁₈ and C₁₄H₂₀. Furthermore, it is desirable that dibutyl ether (C₈H₁₈O) should stay in the staying passage 11. In this case, the insulating film forming chemical X can be prevented from being mixed with the temperature adjusting liquid X4 even if the main piping B1 should be cracked thereby to be broken, whereupon safety can be improved as compared with the conventional construction.

The invention should not be limited to the foregoing embodiments. The embodiments may be modified or expanded as follows. The main piping B1 is disposed centrally in the piping 3 in the foregoing embodiments. However, the main piping may comprise concentric inner and outer pipes, and the insulating film forming chemical X may flow through the inner and outer pipes. In this case, the temperature adjusting liquid X3 is desirable to be caused to flow through an inner liquid passage of the inner pipe and an outer liquid passage of the outer pipe.

The piping 3 has a triple pipe structure in the first embodiment and the piping 10 has a quadruple pipe structure in the second embodiment. However, the piping structure should not be limited to them. The piping may have a double pipe structure, a five or more-fold pipe structure, instead.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A semiconductor manufacturing apparatus comprising:
a main piping distributing an insulating film forming chemical solution onto a semiconductor substrate; and
an auxiliary piping provided so as to surround the main piping so that a liquid chemically nonreactive to the insulating film forming chemical solution flows therethrough.

2. The apparatus of claim 1, wherein the liquid flowing through the auxiliary piping is a temperature adjusting liquid which is circulated through the auxiliary piping.

3. The apparatus of claim 2, wherein the temperature adjusting liquid comprises a liquid which is chemically nonreactive to water.

4. The apparatus of claim 2, wherein the temperature adjusting liquid comprises a liquid containing as an active component at least one of liquids of C₁₀H₈, C₁₀H₁₂, C₁₁H₁₄, C₁₂H₁₆, C₁₃H₁₈ and C₁₄H₂₀.

5. The apparatus of claim 3, wherein the temperature adjusting liquid comprises a liquid containing as an active component at least one of liquids of C₁₀H₈, C₁₀H₁₂, C₁₁H₁₄, C₁₂H₁₆, C₁₃H₁₈ and C₁₄H₂₀.

6. The apparatus of claim 2, wherein the temperature adjusting liquid comprises a liquid which contains as an active component dibutyl ether (C₈H₁₈O).

7. The apparatus of claim 3, wherein the temperature adjusting liquid comprises a liquid which contains as an active component dibutyl ether (C₈H₁₈O).

8. The apparatus of claim 1, wherein the auxiliary piping is disposed immediately near an outer periphery of the main piping.

9. The apparatus of claim 2, wherein the auxiliary piping is disposed immediately near an outer periphery of the main piping.

10. The apparatus of claim 1, further comprising an isolation piping provided so as to surround the main piping and isolate the main and auxiliary pipings from each other with an isolating path being defined therebetween.

11. The apparatus of claim 10, wherein the isolating path isolated by the isolating piping is capable of retaining a buffer liquid chemically non-reactive against the insulating film forming chemical solution.

12. The apparatus of claim 11, wherein the buffer liquid comprises a liquid containing as an active component at least one of liquids of C₁₀H₈, C₁₀H₁₂, C₁₁H₁₄, C₁₂H₁₆, C₁₃H₁₈ and C₁₄H₂₀.

13. The apparatus of claim 11, wherein the buffer liquid comprises a liquid which contains as an active component dibutyl ether (C₈H₁₈O).

14. The apparatus of claim 1, further comprising:
a rotating mechanism which rotates the semiconductor substrate;
a coater cup receiving drops of the insulating film forming chemical solution spun out of the semiconductor substrate by the rotating mechanism after the insulating film forming chemical solution has been caused to drop through the main piping onto the semiconductor substrate; and
a flowing mechanism for causing a cleaning rinse liquid to flow so that the insulating film forming chemical solution adherent to the coater cup is cleaned.

15. The apparatus of claim 14, further comprising a rinse liquid circulator which circulates the cleaning rinse liquid.

16. The apparatus of claim 14, wherein the cleaning rinse liquid comprises a liquid containing as an active component at least one of liquids of C₁₀H₈, C₁₀H₁₂, C₁₁H₁₄, C₁₂H₁₆, C₁₃H₁₈ and C₁₄H₂₀.

17. The apparatus of claim 11, wherein the cleaning rinse liquid comprises a liquid which contains as an active component dibutyl ether (C₈H₁₈O).
